(19) United States
(12) Patent Application Publication
(10) Pub. No.: US 2003/0027472 A1
(43) Pub. Date: Feb. 6, 2003

(54) Cloth structure having waterproof and moisture-permeable properties for waders

(76) Inventor: Byung Nam Hyun, Seoul (KR)

Correspondence Address: HARRISON & EGBERT, 412 MAIN STREET, 7TH FLOOR, HOUSTON, TX, 77002, US

(21) Appl. No.: 09/921,413

(22) Filed: Aug. 2, 2001

(51) Int. Cl. B32B 5/18

(52) U.S. Cl. 442/76

(57) ABSTRACT

Disclosed is a cloth structure having waterproof and moisture-permeable properties for waders, which is treated to be waterproof so as to prevent outside water from passing through the wader, but thermally insulating and breathable so as to permit water vapor from the inside to be eliminated while being stretchable in each direction and possessing a soft feeling, thereby providing a good wearing feeling for the wearer without impeding the wearer's activity. The waterproof and moisture-permeable cloth structure for a wader includes an outer cloth layer of a material freely stretchable in each direction, selected from a group consisting of lycra jersey, nylon jersey and polyester jersey, a cloth layer of a waterproof and moisture-permeable material made of a rubber or vinyl waterproof material having a plurality of holes therein and a cloth material treated with a coating of polyurethane resin having waterproof and moisture-permeable properties so as to enhance the breathability, whereby precipitation or moisture can be eliminated smoothly, and an inner cloth layer of a reticular lining material, which is woven of stretchable filament so as to be stretchable in each direction and having a soft feeling.

### BACKGROUND OF THE INVENTION

1. Field of the Invention

The invention relates to a cloth structure having waterproof and moisture-permeable properties for waders. More particularly, the invention relates to a cloth structure having waterproof and moisture-permeable properties for waders, which is treated to be waterproof so as to prevent outside water from passing through the wader, but thermally insulating and breathable so as to permit water vapor from the inside to be eliminated while being stretchable in each direction and possessing a soft feeling, thereby providing a good wearing feeling for the wearer without impeding the wearer's activity.

2. Description of the Related Art

In general, waders which are fabricated using waterproof cloth are utilized in fishing, particularly wade fishing in which the anglers enter into water or immerse the lower half of their bodies in water for a long period of time, or in working in swampy places such as rice paddy fields or ponds.

Commonly, the waterproof waders used for the above applications have been fabricated using rubber which is excellent in the waterproof property. However, such waders made of rubbers completely intercept the flow of air therethrough. Thus, perspiration or moisture generated inside of the wader while being worn by the wearer cannot be removed from the wader, which may cause dermal diseases to the body.

Also, if the rubber wader is left undried after use, sweat or moisture remaining inside of the wader may propagate microorganisms such as fungi. The propagation of microorganisms emits an offensive odor and moreover, is bad for the health.

Considering the above-described problems involved in the conventional wader, Korean Patent Application No. 1997-11246 suggests a novel cloth structure for waterproof waders. The cloth structure comprises first and second stretchable fabric layers such as nylon, having a moisture-permeable waterproof polyurethane coating formed on at least one of surfaces thereof and a waterproof rubber fabric layer having a plurality of holes formed therein, and interposed between the first and second stretchable fabric layers, in which the waterproof rubber fabric layer is bonded to the first and second flexible fabric layers with an adhesive material. Concrete and detailed description of the above patent application is omitted herein.

The waterproof wader fabricated using the cloth structure of the above invention has improved deodorizing and antibiotic functions as well as breathability. Consequently, the offensive odor caused by a growth of fungi or bacteria resulting from sweat or moisture remaining in the wader in the prior arts is prevented, and the growth of fungi or bacteria is inhibited, leading to advantages of being hygienic and protecting the skin.

However, the waterproof suit fabricated using such waterproof and moisture-permeable cloth structure can provide a desired waterproof and moisture-permeable effect but its lining material which comes into direct contact with the skin has a poor elasticity and therefore, uncomfortable feeling. Accordingly, when fabricating a suit in practice it is necessary to make it bigger than a given body size so that the movement of the wearer should not be inhibited.

Thus, there are problems in that making a waterproof suit unnecessarily bigger leads the increased cost, and the lining material contacting with the skin deteriorates the quality of the product due to its uncomfortable feeling.

### SUMMARY OF THE INVENTION

Therefore, the present invention has been made in order to solve the above-mentioned problems in the related art. An object of the present invention is to provide a waterproof and moisture-permeable cloth structure for waders, which is capable of fabricating a wader according to a given body size without margin because the movement of the wearer of the wader is not inhibited, thereby reducing the use of unnecessary cloth to save the cost, and in which the lining material is excellent in feeling and stretchability, thereby enhancing the quality of the product to arouse the customer's interest.

In order to accomplish the above object, according to the present invention, there is provided a waterproof and moisture-permeable cloth structure for waders comprising:

(A) an outer cloth layer of a material freely stretchable in each direction, selected from a group consisting of lycra jersey, nylon jersey and polyester jersey;

(B) a cloth layer of a waterproof and moisture-permeable material made of a rubber or vinyl waterproof material having a plurality of holes therein and a cloth material treated with a coating of polyurethane resin having waterproof and moisture-permeable properties so as to enhance the breathability, whereby precipitation or moisture can be eliminated smoothly; and

(C) an inner cloth layer of a reticular lining material, which is woven of stretchable filament so as to be stretchable in each direction and having a soft feeling.

### BRIEF DESCRIPTION OF THE DRAWINGS

The above object, and other features and advantages of the present invention will become more apparent after a reading of the following detailed description when taken in conjunction with the drawings, in which:

FIG. 1 is a cross-sectional view illustrating an preferred embodiment according to the present invention; and

FIG. 2 is a cross-sectional view illustrating another preferred embodiment according to the present invention.

### DISCLOSURE OF THE PREFERRED EMBODIMENTS

Now, the present invention will be described in detail.

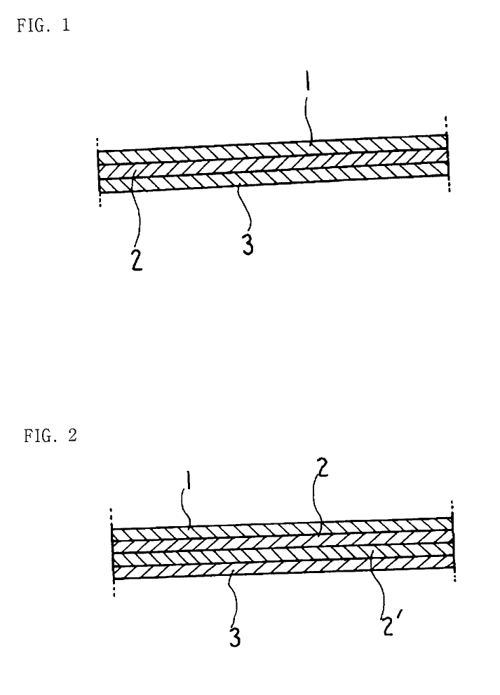

Referring to FIG. 1, the reference number 2 represents a cloth layer of a waterproof and moisture-permeable material. As the waterproof and moisture-permeable material, the waterproof and moisture-permeable material as described in Korean Patent Application No. 1997-11246 applied by the present applicant is used. More particularly, the cloth material is made by bonding a cloth material treated with a coating of synthetic resin having waterproof and moisture-permeable properties to a waterproof rubber or vinyl material having a plurality of holes therein so that the breathability is improved and perspiration or moisture can be eliminated smoothly.

The lining cloth layer 3 which is laminated on a surface of the above-described waterproof and moisture-permeable cloth is prepared from freely stretchable yarns such as nylon yarn, polyester yarn, spandex yarn, natural or artificial rubber yarn in a net shape so that the cloth is freely stretchable and have a soft feeling.

The outer cloth layer 1 which is laminated on another surface of the above-described waterproof and moisture-permeable cloth layer also should be freely stretchable. Lycra jersey, nylon jersey, polyester jersey and the like may be used.

The cloth structure according to the present invention is formed by bonding the reticulate lining cloth layer to a surface of the waterproof and moisture-permeable cloth layer by means of an adhesive material and then bonding the outer cloth layer to the remaining surface of the waterproof and moisture-permeable cloth layer by means of an adhesive material.

FIG. 2 is a cross-sectional view illustrating another embodiment according to the present invention. The cloth structure shown in FIG. 2 may be prepared by bonding an outer cloth layer of a stretchable material 1 to a waterproof and moisture-permeable cloth layer 2. A lining cloth of stretchable reticulate material 3 is bonded to another waterproof and moisture-permeable cloth 2′. Then, the two above-described laminates are bonded together by means of an adhesive material in such a fashion that waterproof and moisture-permeable cloth layers 2 and 2′ face each other. By this arrangement, the breathability and waterproof effect of the waterproof and moisture-permeable cloth structure according to the present invention can be maximized.

The cloth structure according to the present invention is prepared as a single layer cloth by bonding a lining cloth layer and an outer cloth layer to surfaces of a waterproof and moisture-permeable cloth layer using an adhesive material. It may be used for fabrication of waterproof suits such as a wader or ski suit.

In more detail, the lining cloth layer 3 of the cloth structure according to the present invention is made of a material being freely stretchable and having a good feeling. Therefore, in fabricating a waterproof suit such as a wader or a ski suit, it is possible to make the suit fit the actual body size without margin. Wearers will enjoy their activities without any hindrance resulting from the roughness or tightness of the suit and feel comfortable while wearing the suit because of the soft feeling of the lining cloth. Ultimately, by the enhancement of the product quality, the consumer's interest is aroused and future sales are secured.

In order to further enhance the waterproof and moisture-permeability of the cloth structure according to the present invention, it is also possible to laminate two or more layers of waterproof and moisture-permeable cloth interposed between the outer cloth layer and the lining cloth layer.

Meanwhile, in the conventional method for fabricating waterproof suits, edges of the pieces cut from the cloth are joined to each other by directly using an adhesive material, or by stitching them using a sewing machine to form a seam and then covering the seam with a waterproof tape using a hot melt adhesive. However, when fabricating a waterproof suit using the cloth structure according to the present invention, the above-described joining methods may lead to problems associated with impairing the waterproof property.

Preferably, in order to join the edges of the cloth pieces cut from the cloth structure according to the present invention, firstly, the edges are stitched using a sewing machine, thereby forming a seam. Then, a thermosetting adhesive or a rubber-based adhesive is applied over the seam, as a primary waterproof treatment. Over the seam thus-treated, a waterproof tape of a hot melt adhesive type is further applied.

As described above, the cloth structure for waterproof suits such as waders or ski suits according to the present invention comprises a single or multiple layered waterproof and moisture-permeable cloth. Accordingly, perspiration or moisture inside of the suits can be removed, whereby propagation of bacteria such as fungi can be prevented, thereby being hygienic. Also, since the lining cloth is freely stretchable and excellent in feeling, the movements of the wearer are not inhibited even when the suit is fabricated to fit the body size of the wearer without margin. Further, it is possible to cut down the cost through the saving of the cloth. In addition, because the lining cloth contacting to the skin has a soft feeling, which favorably affects the consumer's opinion of the product, the consumer is induced to make future purchase.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed:

1. A waterproof and moisture-permeable cloth structure for a wader comprising:
(A) an outer cloth layer of a material freely stretchable in each direction, selected from a group consisting of lycra jersey, nylon jersey and polyester jersey;
(B) a cloth layer of a waterproof and moisture-permeable material made of a rubber or vinyl waterproof material having a plurality of holes therein and a cloth material treated with a coating of polyurethane resin having waterproof and moisture-permeable properties so as to enhance the breathability, whereby precipitation or moisture can be eliminated smoothly; and
(C) an inner cloth layer of a reticular lining material, which is woven of stretchable filament so as to be stretchable in each direction and having a soft-feeling.

2. The cloth structure according to claim 1, wherein the cloth layer of a waterproof and moisture-permeable material is a laminate comprising a plurality of cloth layers of a waterproof and moisture-permeable material.

3. The cloth structure according to claim 1, wherein the inner cloth layer of a reticular lining material is woven of stretchable filament selected from nylon filament, polyester filament, spandex filament, or natural or artificial rubber filament.

4. A method for joining contiguous edges of cloth pieces cut from the waterproof and moisture-permeable cloth structure according to claim 1 in fabricating waders comprising steps of:
stitching the contiguous edges of cloth pieces using a sewing machine, thereby forming a seam;
applying a thermosetting adhesive or a rubber-based adhesive over the seam, thereby waterproofing the seam; and
applying a waterproof tape of a hot melt adhesive type over the seam primarily waterproof treated in the above step.
